(19) United States
(12) Patent Application Publication
(10) Pub. No.: US 2026/0211219 A1
(43) Pub. Date: Jul. 23, 2026

(54) Variable-effect filtering device

(71) Applicant: THALES, Meudon (FR)

(72) Inventors: Bruno COUMERT, Saint Heand (FR); Jean-Yves LE POULAIN, Saint Etienne (FR)

(21) Appl. No.: 19/139,163

(22) PCT Filed: Dec. 18, 2023
(86) PCT No.: PCT/EP2023/086393

§ 371 Date: Jun. 13, 2025

(30) Foreign Application Priority Data
Dec. 19, 2022 (FR) FR2213771

(51) Int. Cl. G02B 13/16; G03B 9/06; G03B 11/00

(52) U.S. Cl. CPC G02B 13/16; G03B 9/06; G03B 11/00

(57) ABSTRACT

The present invention relates to a variable-effect filtering device (12), comprising:
a filter (20) presenting a working surface (23) comprising a central zone (Z_{C}) and a peripheral zone (Zₚ), the filter (20) having a predefined optical property over a filtering zone, the filtering zone being the central zone (Z_{C}) or the peripheral zone (Zₚ) or the entirety of the working surface (23), and
a diaphragm (22) having an opening that is adjustable between the full opening of the diaphragm (22) and the maximum closure of the diaphragm (22) the diaphragm (22) being positioned relative to the filter (20) so that the modification of the opening of the diaphragm (22) modifies the accessible portion of the filtering zone or the accessible portion of another zone of the working surface (23), allowing a modification of the filtering effect to be induced.

The present invention relates to a variable-effect filtering device. The present invention also relates to an assembly comprising an image-taking objective and such a filtering device. The present invention also relates to a method for modifying the rendering of the image using such a filtering device.

The present invention relates to the film industry, and to image-taking in general.

In particular, in the film industry, camera operators choose their lenses depending on the film to be made, as well as their preference for such a family of lenses considered as suitable for their lighting methods. Indeed, some lenses may be softer, in other words have less contrast on intermediate frequency patterns (5 to 50 cy/mm), while having good resolution (>150 cy/mm) for S35 to FF (full frame) sensors. Others, on the other hand, are considered hard due to their very good quality (or modulation transfer function) at intermediate frequencies. Thus, the choice of a specific contrast is (in part) achieved depending on the choice of lenses.

However, this modularity is limited by the need to have a range of focal lengths having the same performance for a given sequence.

Diffuser filters can be used in front of or behind the lens. However, there is a risk of seeing the texture of the diffuser in the bokeh (background blur) of the image.

It is also possible to displace the lenses in order to reduce contrast by spreading aberrations. However, the rendering is not that of a diffuser and is not uniform across the field.

There is therefore a need for a device allowing the modification of the rendering of the image formed by a lens, in a simple and adaptable manner at any time.

To this end, the present description has as its object a variable-effect filtering device, comprising:
a. a filter presenting a working surface comprising a central zone and a peripheral zone surrounding the central zone, the filter having a predefined optical property over a zone, called filtering zone, the filtering zone being either the central zone, or the peripheral zone, or the entirety of the working surface, and
b. a diaphragm with an adjustable opening between the diaphragm being fully open and the diaphragm being fully closed, the diaphragm being positioned relative to the filter so that the full opening of the diaphragm corresponds to the working surface of the filter and that modification of the opening of the diaphragm modifies the accessible portion of the filtering zone or the accessible portion of another zone of the working surface, allowing a modification of the filtering effect to be induced.

According to particular embodiments, the device comprises one or more of the following features, taken alone or in any technically possible combination:
the filtering zone is the central zone or the peripheral zone, the predefined optical property being uniform over the filtering zone.
the predefined optical property presents a progressive radial variation over the filtering zone.
the full opening of the diaphragm delimits the peripheral zone of the filter.
the filtering zone and the opening formed by the diaphragm have substantially the same shape to within near homothety.
the central zone has a shape chosen from among one of the following shapes:
circular, square, rectangular, parallelepiped, triangular, oval, and star-shaped.
the predefined optical property is chosen from among one of the following properties: a diffusion property, a polarization property, a colorimetric property, a wavefront deformation property, a transparency property, and a combination of at least two of the preceding properties.
the filtering zone is the central zone or the peripheral zone, the working surface of the filter comprising at least one intermediate zone surrounding the central zone and surrounded by the peripheral zone, the at least one intermediate zone comprising a progressive radial variation of the predefined optical property between the central zone and the peripheral zone.
the diaphragm is an iris diaphragm.

The present description also relates to an assembly comprising:
a. an image-taking objective, and
b. a filtering device, the device being positioned substantially at the aperture of the image-taking objective, allowing the modification of the rendering of the image formed by the image-taking objective.

The present description also relates to a method for modification of the rendering of the image formed by an image-taking objective, the method comprising:
a. the positioning of a filtering device, such as described above, substantially at the aperture of the image-taking objective, and
b. the modification of the opening of the diaphragm, so as to modify the accessible portion of the filtering zone or the accessible portion of another zone of the working surface, such as to induce a modification of the filtering effect, allowing the modification of the rendering of the image formed by the image-taking objective.

Other features and advantages of the invention will become apparent from the following description of embodiments of the invention, given by way of example only and with reference to the drawings which are:

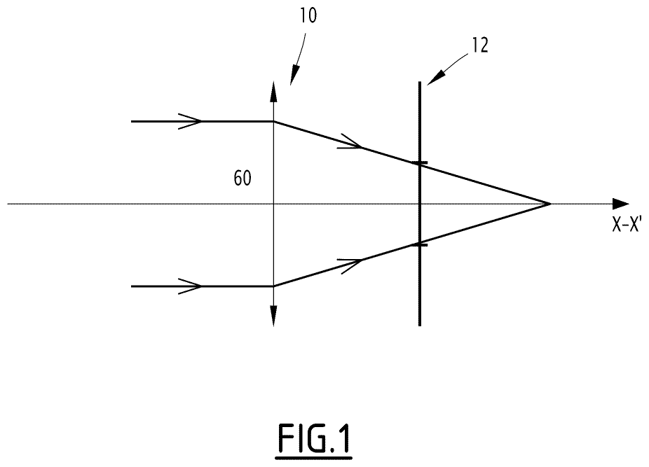

FIG. 1, a schematic representation of an assembly comprising an image-taking objective and a filtering device,

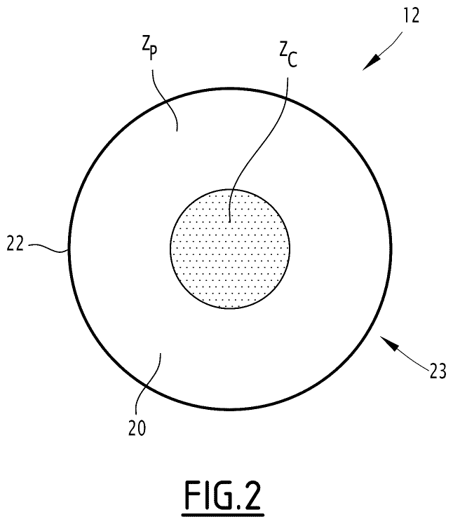

FIG. 2, a schematic representation of a filtering device according to a first embodiment, the diaphragm of the filtering device being fully open,

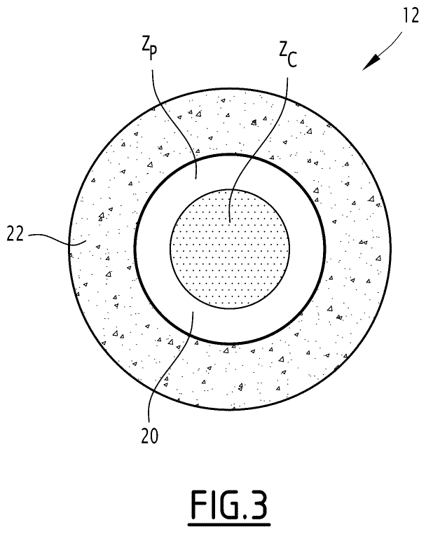

FIG. 3, a schematic representation of the filtering device of FIG. 2, the diaphragm of the filtering device being at an intermediate opening,

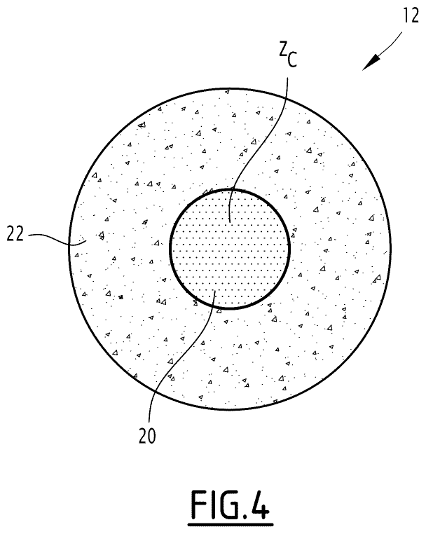

FIG. 4, a schematic representation of the filtering device of FIG. 2, the diaphragm of the filtering device being at another intermediate opening,

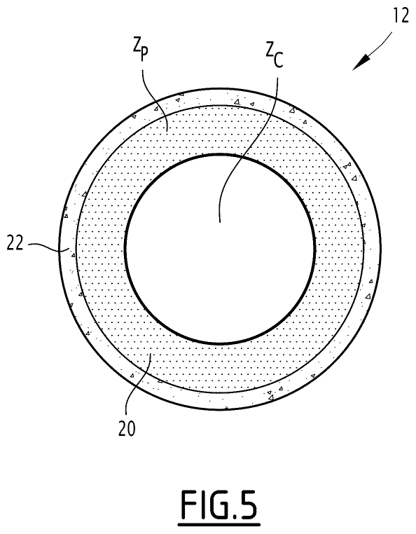

FIG. 5, a schematic representation of a filtering device according to a second embodiment, the diaphragm of the filtering device being at an intermediate opening,

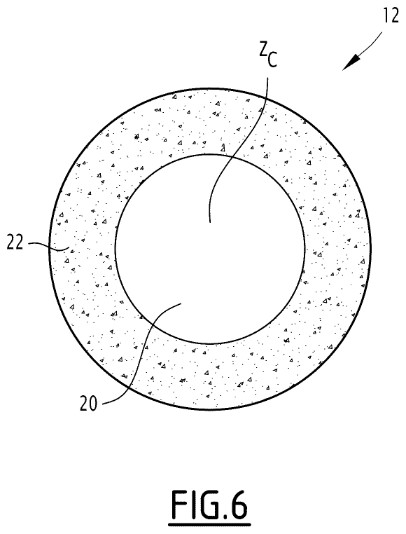

FIG. 6, a schematic representation of the filtering device of FIG. 5, the diaphragm of the filtering device being at another intermediate opening, and

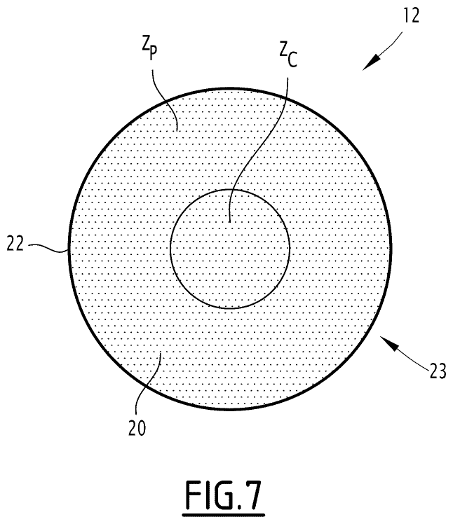

FIG. 7, a schematic representation of a filtering device according to a third embodiment, the filtering zone extending over the entire working surface of the filter.

An image-taking objective 10 and a filtering device 12 are illustrated in FIG. 1.

The image-taking objective 10 is able to form an image of a scene on a sensor. The image-taking objective 10 is, for example, a lens or zoom lens of a camera or movie camera. The image-taking objective 10 typically comprises at least one lens, and usually a set of lenses.

The filtering device 12 is able to generate a variable filtering effect. The term “variable,” means that the filtering is made to vary depending on the configuration (adjustment) of the filtering device 12. The adjustment can be made easily in less than a second.

The filtering device 12 is intended to be positioned substantially at the aperture of the image-taking objective 10 (as is the case in FIG. 1), in order to modify the to the rendering of the image formed by the image-taking objective 10. The term “substantially” means “near”, or, more precisely, at a distance less than a predetermined distance from the aperture. The predetermined distance is, for example, equal to 2 mm.

The filtering device 12 comprises a filter 20 and a diaphragm 22.

The filter 20 is a planar optical filter. The filter 20 is, for example, made of a material such as glass or plastic.

As illustrated in the examples of FIGS. 2 to 6, the filter 20 comprises a working surface 23 comprising a central zone Z_{C} and a peripheral zone Z_{P} surrounding the central zone Z_{C}. In the examples of FIGS. 2 to 6, the working surface 23 extends over the entire surface of the filter 20. Alternatively, the working surface 23 extends over only a portion of the filter 20.

Preferably, the surface of the central zone Z_{C} is at least equal to 30 percent of the surface of the peripheral zone Z_{P}.

Preferably, the central zone Z_{C} has a shape chosen depending on the desired rendering. The shape of the central zone Z_{C} is, for example, chosen from among one of the following shapes: circular, square, rectangular, parallelepiped, triangular, oval, and star-shaped. More generally, the shape of the central zone Z_{C} is any shape achievable by an adjustable opening diaphragm, such as an iris diaphragm.

In the examples of FIGS. 2 to 6, the central zone Z_{C} is circular.

The filter 20 presents a predefined optical property over only one of the central zone Z_{C} and the peripheral zone Z_{P}, called the filtering zone. The other zone thus presents a different optical property.

For example, in the embodiment of FIGS. 2 to 4, the filtering zone is the central zone Z_{C}, while in that of FIGS. 5 and 6, the filtering zone is the peripheral zone Z_{P}.

Preferably, the predefined optical property is chosen from among one of the following properties: a diffusion property (a diffusing filtering zone and a non-diffusing zone), a polarization property (a polarized filtering zone and a non-polarized zone), a colorimetric property (a colored filtering zone and a non-colored zone), a wavefront deformation property, a transparency property (a transparent filtering zone and an opaque or partially transparent zone), an opacity property (an opaque or partially transparent filtering zone and another transparent zone), and a combination of at least two of the preceding properties. The value of the optical property is adapted depending on the desired rendering.

In one example embodiment, the predefined optical property is uniform over the filtering zone.

Alternatively, the predefined optical property presents a radial variation over the filtering zone. The variation is thus progressive and continues radially. For example, in the case of a diffusing property, the diffusion continues increasing from the center of the filtering zone toward the periphery of the filtering zone, or conversely.

In one optional embodiment, the filter 20 further comprises an intermediate zone surrounding the central zone Z_{C} and surrounded by the peripheral zone Z_{P}. The intermediate zone comprises a progressive (radial) variation of the predefined optical property between the central zone Z_{C} and the peripheral zone Z_{P}. This allows to avoid a discontinuous variation of the optical property between the central zone Z_{C} and the peripheral zone Z_{P}, notably in the case where the optical property is uniform over the filtering zone.

The diaphragm 22 presents an adjustable opening between the full opening of the diaphragm 22 and the maximum closure of the diaphragm 22.

Preferably, the opening is continuously adjustable between the full opening of the diaphragm 22 and the maximum closure of the diaphragm 22. The adjustment is, for example, made by an adjustment mechanism. The diaphragm 22 is, for example, an iris diaphragm.

The diaphragm 22 is positioned relative to the filter 20 so that:
the full opening of the diaphragm corresponds to the working surface 23 of the filter 20, and
the modification of the opening of the diaphragm 22 modifies the accessible portion of the filtering zone or the accessible portion of another zone of the working surface 23, allowing a modification of the filtering effect to be induced. In other words, this modifies the accessible proportion of the filtering zone relative to the other zone (that is, the ratio between the unobstructed portion of the filtering zone and the unobstructed portion of the other zone). The term “accessible” means accessible for an optical flux or “useful.”

Preferably, the accessible portion of the filtering zone or the accessible portion of another zone of the working surface 23 is modified radially during the modification of the opening of the diaphragm 22. In the examples of FIGS. 2 to 6, both the accessible portion of the filtering zone and the accessible portion of the other zone are able to be modified radially. The term “radially” means in the plane of the filter 20 and perpendicular to an axis passing substantially through the center of the central zone Z_{C} and substantially perpendicular to the plane of the filter 20. The considered axis is the optical axis of the image-taking objective 10 when the filtering device 12 is positioned substantially at the aperture of the image-taking objective 10. In this case, the filtering device 12 is positioned relative to the image-taking objective 10 so that the filter 20 is positioned substantially perpendicular to the optical axis of the image-taking objective 10 and the center of the central zone Z_{C} of the filter 20 is substantially on the optical axis of the image-taking objective 10.

Preferably, the opening of the diaphragm 22 is centered on the center of the central zone Z_{C}.

Preferably, the full opening of the diaphragm 22 delimits the peripheral zone Z_{P} of the filter 20.

Preferably, the maximum closure of the diaphragm 22 completely obstructs the central zone Z_{C} and the peripheral zone Z_{P} of the filter 20.

Preferably, the central zone Z_{C} and the opening formed by the diaphragm 22 have substantially the same shape (except to within near homothety). In the examples of FIGS. 2 to 6, the central zone Z_{C} and the opening thus have a circular shape.

A method for modification, via the filtering device 12, of the rendering of the image formed by the image-taking objective 10 will now be described.

The filtering device 12 is positioned relative to the image-taking objective 10 so as to be substantially at the aperture of the image-taking objective 10. The filtering device 12 is preferably positioned so that the optical axis of the image-taking objective 10 passes through the center of the central zone Z_{C} of the filter 20 and is perpendicular to the plane of the filter 20.

The opening of the diaphragm 22 is then modified so as to radially modify the accessible portion of the filtering zone or the accessible portion of another zone of the working surface 23, allowing the modification of the rendering of the image formed by the image-taking objective 10. Typically, when the property is a diffusing property, depending on the opening of the diaphragm 22, the image is rendered more or less blurry (“softener” effect). Thus, by opening or closing the diaphragm 22, for example by the simple rotation of a ring, it is possible to notably modify the characteristics of the image that will be formed by the objective.

In the embodiment of FIGS. 2 to 4, only the central zone Z_{C} presents a diffusing property. Such a property allows to modify the contrast of the image (the image is softened the more that light is allowed to pass through a diffusing zone). In the case of FIG. 2, the diaphragm 22 is fully open, which means that about 14% of the aperture is diffused. In FIG. 3, the opening of the diaphragm 22 is intermediate (T3.6), still allowing a portion of the peripheral zone Z_{P} to appear, which means that about 40% of the aperture is diffused. In FIG. 4, the opening of the diaphragm 22 is intermediate (T5.6) and completely masks the peripheral zone Z_{P}, which means that 100% of the aperture is diffused.

In the embodiment of FIGS. 5 and 6, only the peripheral zone Z_{P} presents a diffusing property. In the case of FIG. 5, the diaphragm 22 is at an intermediate opening still allowing a portion of the peripheral zone Z_{P} to appear, meaning that the diffusion of the aperture apparent. In the case of FIG. 6, the diaphragm 22 completely masks the peripheral zone Z_{P}, meaning that the aperture is not diffused.

Thus, the filtering device 12 allows to modify, in a simple and quick manner, the rendering of the image formed by an image-taking objective 10. The adjustment is performed outside the objective and can be done at any time, for example via the rotation of a diaphragm ring 22 that allows it to be opened or closed.

Such an optical filter is also inexpensive and simple to produce. For example, in the case of diffusion, the filter can be composed of a plastic film (Mitchell filter) glued between two plates or by a frosted plate in the desired surfaces, or by a holographic diffuser, or by gluing a grill, or any other diffusion principle.

Furthermore, it should be noted that the present invention allows the same filtering effect to be obtained, for the same diaphragm opening 22 and for the objectives of the same series, but of different focal lengths, provided the dimensions of the filter 20 (accessible portion of the central zone Z_{C} and the peripheral zone Z_{P} in particular) are adapted.

Although the examples in the description have highlighted the diffusion properties, the invention applies to all types of optical properties allowing to modify the rendering of the image formed by an objective depending on the opening of a diaphragm.

Furthermore, it should be noted that the filtering device is not limited to the case where the filtering zone extends over only one of the central zone Z_{C} or the peripheral zone Z_{P}. Indeed, in one alternative implementation illustrated in FIG. 7, the filtering zone extends over the entire working surface 23 of the filter 20. In this case, the modification of the opening of the diaphragm 22 modifies only the accessible portion of the filtering zone (and not of another zone of the working surface 23 since the filtering zone occupies the entire working surface 23). Preferably, the predefined optical property presents a continuous progressive variation (radial) over the filtering zone. For example, in the case of a diffusing property, the diffusion continues increasing from the center of the working surface 23 (central zone) toward the periphery of the working surface 23 (peripheral zone), or conversely. The other features described previously, notably for the embodiments of FIGS. 2 to 6, also apply to this additional embodiment.

More generally, a person skilled in the art will understand that the previously described embodiments and alternatives can be combined with each other provided they are technically compatible.

1. A variable-effect filtering device, comprising:
a filter presenting a working surface comprising a central zone and a peripheral zone, surrounding the central zone, the filter having a predefined optical property over a zone, called the filtering zone, the filtering zone being the central zone or the peripheral zone or the entirety of the working surface, and
a diaphragm having an opening adjustable between the full opening of the diaphragm and the maximum closure of the diaphragm, the diaphragm being positioned relative to the filter so that the full opening of the diaphragm corresponds to the working surface of the filter and that the modification of the opening of the diaphragm modifies the accessible portion of the filtering zone or the accessible portion of another zone of the working surface, allowing a modification of the filtering effect to be induced.

2. The device according to claim 1, wherein the filtering zone is the central zone or the peripheral zone, the predefined optical property being uniform over the filtering zone.

3. The device according to claim 1, wherein the predefined optical property presents a progressive radial variation over the filtering zone.

4. The device according to claim 1, wherein the full opening of the diaphragm delimits the peripheral zone of the filter.

5. The device according to claim 1, wherein the filtering zone and the opening formed by the diaphragm have substantially the same shape except to within near homothety.

6. The device according to claim 1, wherein the central zone (Z_{C}) has a shape chosen from among one of the following shapes: circular, square, rectangular, parallelepiped, triangular, oval, and star-shaped.

7. The device according to claim 1, wherein the predefined optical property is chosen from among one of the following properties: a diffusion property, a polarization property, a colorimetric property, a wavefront deformation property, a transparency property, and a combination of at least two of the preceding properties.

8. The device according to claim 1, wherein the filtering zone is the central zone or the peripheral zone, the working surface of the filter comprising at least one intermediate zone surrounding the central zone and surrounded by the peripheral zone, the at least one intermediate zone comprising a progressive radial variation of the predefined optical property between the central zone and the peripheral zone.

9. The device according to claim 1, wherein the diaphragm is an iris diaphragm.

10. An assembly comprising:
a. an image-taking objective, and
b. a filtering device according to claim 1, the device being positioned substantially at the aperture of the image-taking objective, allowing the modification of the rendering of the image formed by the image-taking objective.

11. A method for modifying the rendering of the image formed by an image-taking objective, the method comprising:
a. the positioning of a filtering device according to claim 1 substantially at the aperture of the image-taking objective, and
b. the modification of the opening of the diaphragm so as to modify the accessible portion of the filtering zone or the accessible portion of another zone of the working surface so as to induce a modification of the filtering effect, allowing the modification of the rendering of the image formed by the image-taking objective.
